(19) United States
(12) Patent Application Publication
(10) Pub. No.: US 2006/0226156 A1
(43) Pub. Date: Oct. 12, 2006

(54) Paint distribution device

(76) Inventors: Michael J. Lundy, Mesa, AZ (US); Ronald D. Pike, Phoenix, AZ (US)

Correspondence Address: ROBERT A. PARSONS, 4000 N. CENTRAL AVENUE, SUITE 1220, PHOENIX, AZ, 85012, US

(21) Appl. No.: 11/101,808

(22) Filed: Apr. 8, 2005

(51) Int. Cl. B05C 21/00

(52) U.S. Cl. 220/570

(57) ABSTRACT

A paint distribution device includes a brush holder vessel having an open top defined by a rim, and a collar extending from around the rim. A paint distribution panel is coupled at a top edge to the collar with a back surface facing and spaced apart from the brush holder vessel. A slot is defined by a flange extending downwardly for an edge of the collar opposite the paint distribution panel and the brush holder vessel for receipt of a bucket rim.

### FIELD OF THE INVENTION

This invention relates to painting equipment.

More particularly, the present invention relates to painting accessories.

### BACKGROUND OF THE INVENTION

Devices for removing excess paint from rollers have long been known and used in the painting industry. Paint roller pens are traditionally used, and include a shallow pan sloped from a shallow end to a deeper end. Paint is deposited in the pan and a roller is dipped therein. Excess paint is removed by rolling the roller on the sloped bottom. Professional painters, typically painting larger structures, often use paint directly from large paint buckets such as the 5 gallon bucket in which paint is often supplied. The problem of removing excess paint from paint rollers has been solved by employing paint roller grids. Roller grids conventionally consist of a metal frame supporting a wire grid. The metal frame includes a pair of widely spaced apart brackets. The brackets are received over the rim of the paint bucket supporting the metal frame down a side of the bucket. Metal frames are required to provide the necessary rigidity and strength for the device. The metal frame must maintain the flat shape of the grid during removal of excess paint from the roller without bending and flexing between the pair of brackets.

Often, additional tools such as trimming brushes, sponges and the like are employed in a painting operation. Conventional roller grids do not include any structures for supporting or holding these accessory tools.

It would be highly advantageous, therefore, to remedy the foregoing and other deficiencies inherent in the prior art.

Accordingly, it is an object of the present invention to provide a new and improved paint distribution device which is supported along an entire top edge to provide strength and rigidity during use.

### SUMMARY OF THE INVENTION

Briefly, to achieve the desired objects of the present invention in accordance with a preferred embodiment thereof, provided is a paint distribution device including a brush holder vessel having an open top defined by a rim, a collar extending from around the rim, and a paint distribution panel having a front surface, a back surface, and a top edge. The top edge is coupled to the collar with the back surface facing and spaced apart from the brush holder vessel. A slot is defined by a flange extending downwardly for an edge of the collar opposite the paint distribution panel and the brush holder vessel for receipt of a bucket rim.

In a further aspect, the collar includes a flat edge with a first end and a second end, and a curved edge extending from the first end to the second end around the rim. The flange defining the slot extends around the curved edge.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a front perspective view of the paint distribution device according to the present invention as it would appear carried by a bucket;

FIG. 2 is a rear perspective view of the paint distribution device carried by a bucket of FIG. 1;

FIG. 3 is a perspective view of the paint distribution device according to the present invention;

FIG. 4 is a rear perspective view of the paint distribution device of FIG. 3;

FIG. 5 is a bottom perspective view of the paint distribution device of FIG. 3;

FIG. 6 is a top plan view of the paint distribution device of FIG. 3; and

FIG. 7 is a side plan view of the paint distribution device of FIG. 3.

### DETAILED DESCRIPTION OF THE PREFERRED EMBODIMENT

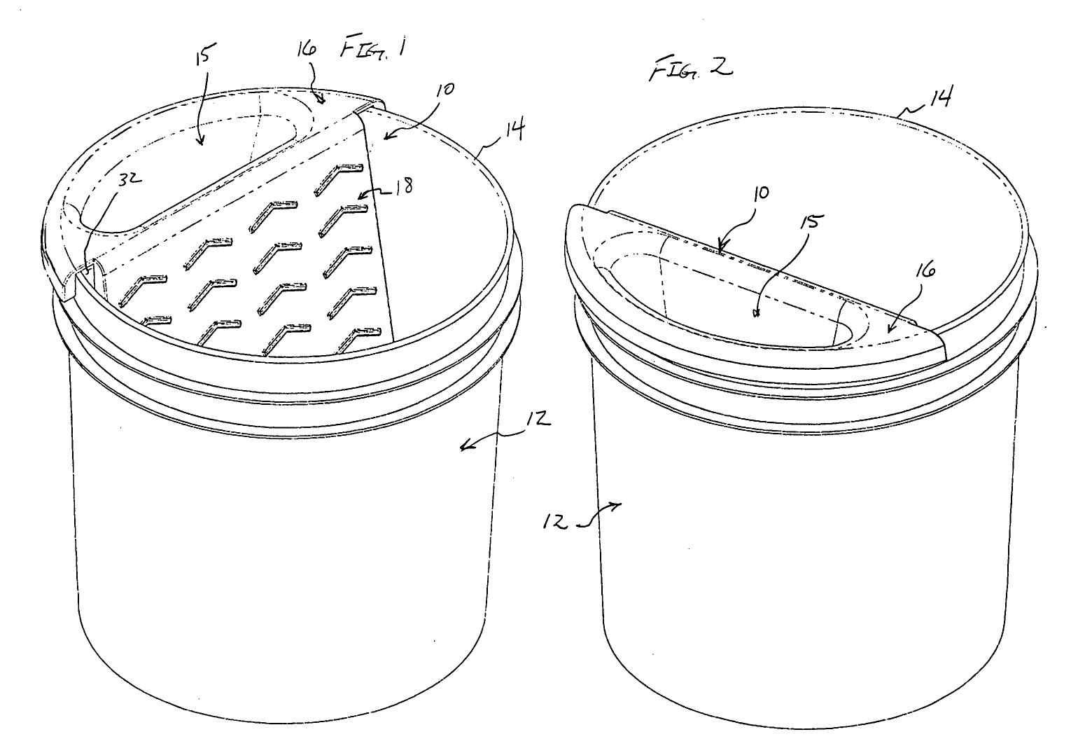

Turning now to the drawings in which like reference characters indicate corresponding elements throughout the several views, attention is first directed to FIGS. 1 and 2 which illustrate a paint distribution device generally designated 10, as it would appear carried in any bucket 12. Bucket 12 can be any conventional bucket having an open top defined by a rim 14. However, in the preferred embodiment, bucket 12 is a conventional 5 gallon bucket typically used to carry and supply paint. Device 10 includes a brush holder vessel 15, a collar 16, and a paint distribution panel 18. Collar 16 extends from vessel 15 and supports paint distribution panel 18 within bucket 12.

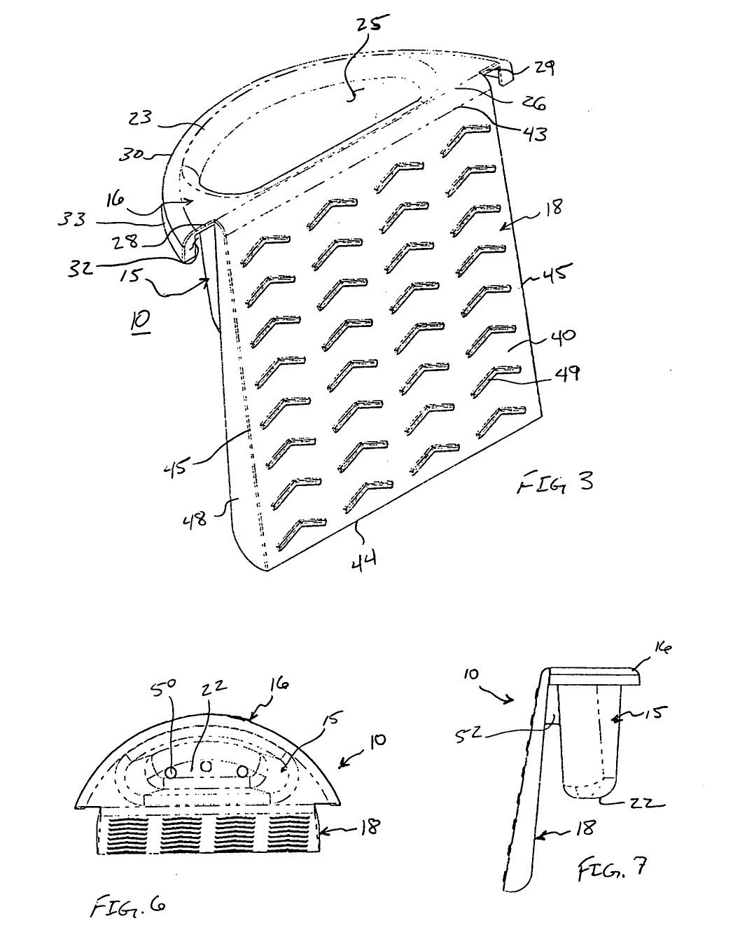

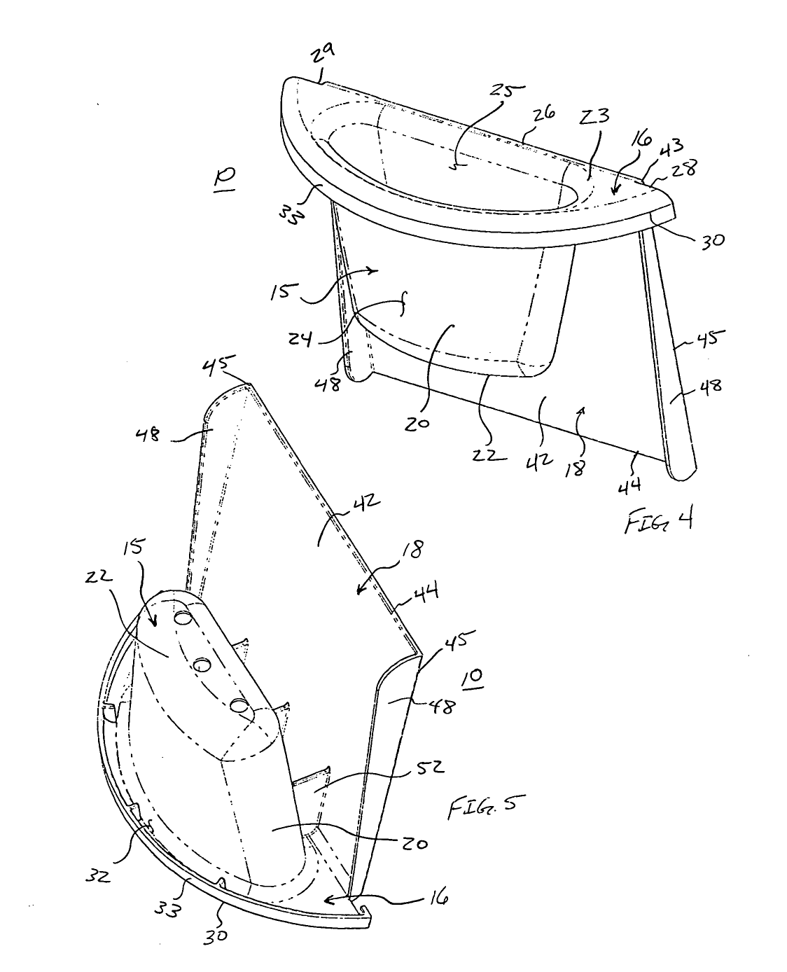

Turning now to FIGS. 3, 4, and 5, paint distribution device 10 is clearly illustrated. Brush holder vessel 15 includes a continuous sidewall 20 extending from a bottom 22 to a rim 23. Sidewall 20 and bottom 22 define a volume 24 accessed by an open top 25. Open top 25 is defined by rim 23, which in this preferred embodiment is rolled to provide a smooth transition between collar 16 and brush holder vessel 15. Brush holder vessel 15 is shaped preferably to accept a paint brush, but can have other shapes as desired. Most notably, brush holder vessel 15 includes a length from side to side greater than a width from front to back.

Collar 16 is coupled to and surrounds rim 23 of brush holder vessel 15. Collar 16 is generally a continuation of the rolled edge of rim 23 and includes a flat edge 26 with a first end 28 and a second end 29. A curved edge 30 extends from first end 28 to second end 29 around rim 23. A slot 32 is defined by a flange 33 extending downwardly from curved edge 30 of collar 16. Flange 33 extends substantially the entire length of curved edge 30 from first end 28 to second end 29.

Paint distribution panel 18 has a front surface 40, a back surface 42, a top edge 43, a bottom edge 44, and opposing side edges 45. Top edge 43 is coupled to flat edge 26 of collar 16, with back surface 42 facing and spaced apart from sidewall 20 of brush holder vessel 15. The entire length of top edge 43 is coupled to and therefore supported by collar 16. Additional rigidity is added to paint distribution panel 18 by a flange 48 extending from each opposing side edge 45. Flanges 48 extend substantially the entire length of opposing side edges 45 and are disposed at an angle thereto. In the preferred embodiment, flanges 48 are substantially perpendicular to paint distribution panel 18 providing vertical rigidity thereto although angles greater or less than 90 degrees may be employed. Front surface 40 is textured it to provide paint distributing characteristics. The texturing is preferably provided by a plurality of protrusions formed therein. While substantially any shaped protrusion may be employed, downwardly directed chevron shaped protrusions 49 are preferred. The downward angle of the arms of each chevron 49 allows paint to drain downwardly into bucket 12 after removal from the paint roller.

Slot 32 extends from curved edge 30 of collar 16 opposite paint distribution panel 18 and receives rim 14 of bucket 12 therein with brush holder vessel 15 and paint distribution panel 18 suspended within bucket 12. In this manner, the entirety of curved edge 30 engages rim 14 of bucket 12 providing secure attachment thereto and support therefrom. Thus, the entire length of collar 16 is supported, in turn supporting the entire width of paint distribution panel 18.

Referring now to FIGS. 6 and 7, brush holder vessel 15 includes drain holes 50 formed in bottom 22 thereof. Drain holes 50 permit paint to drain from a brush stored therein and back into bucket 12. To provide additional support and rigidity between paint distribution panel 18 and brush holder vessel 15, braces 52 are provided which extend from brush holder vessel 15 to back surface 42 of paint distribution panel 18. For purposes of stackability of a plurality of device is 10, braces 52 are preferably limited to back surface 42 proximate top edge 43 and sidewall 20 proximate rim 23. Thus, brush holder vessel 15 of another paint distribution device 10 can be received within brush holder vessel 15. The paint distribution panel 18 of the additional device 10 will overlie the paint distribution panel 18 of the device 10 in which brush holder vessel 15 is received. Additionally, front surface 40 of paint distribution panel 18 is slightly angled with respect to collar 16. In other words, paint distribution panel 18 slopes away from brush holder vessel 15 from top edge 43 to bottom edge 44. The degree of slope can be altered as desired for the proper operation of panel 18.

Since paint distribution panel 18 is supported along the entirety of top edge 43, and further strengthened by flanges 48, materials of lesser strength than those used in conventional roller grids, such as metal, may be employed. In the preferred embodiment, paint distribution device 10 is fabricated as a single integral piece from molded plastic materials.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A paint distribution device comprising:
a brush holder vessel having an open top defined by a rim;
a collar extending from around the rim;
a paint distribution panel having a front surface, a back surface, and a top edge, the top edge coupled to the collar with the back surface facing and spaced apart from the brush holder vessel; and
a slot defined by a flange extending downwardly for an edge of the collar opposite the paint distribution panel and the brush holder vessel for receipt of a bucket rim.

2. A paint distribution device as claimed in claim 1 wherein the front surface of the paint distribution panel includes a plurality of protrusions.

3. A paint distribution device as claimed in claim 1 wherein the brush holder vessel includes drain holes formed in a bottom thereof.

4. A paint distribution device as claimed in claim 1 wherein the collar includes a flat edge with a first end and a second end, and a curved edge extending from the first end to the second end around the rim.

5. A paint distribution device as claim in claim 4 wherein the paint distribution panel includes opposing side edges each having a flange extending therefrom at an angle.

6. A paint distribution device as claimed in claim 1 further including braces extending from the brush holder vessel to the back surface of the paint distribution panel.

7. A paint distribution device comprising:
a brush holder having continuous sidewall extending from a bottom to a rim defining an open top;
a collar coupled to and surrounding the rim, the collar having a flat edge with a first end and a second end, and a curved edge extending from the first end to the second end around the rim;
a paint distribution panel having a front surface, a back surface, a top edge, a bottom edge, and opposing side edges, the top edge coupled to the flat edge of the collar with the back surface facing and spaced apart from the brush holder; and
a slot defined by a flange extending downwardly from the curved edge of the collar opposite the paint distribution panel and the brush holder.

8. A paint distribution device as claimed in claim 7 wherein the front surface of the paint distribution panel includes a plurality of protrusions.

9. A paint distribution device as claimed in claim 7 wherein the brush holder includes drain holes formed in the bottom thereof.

10. A paint distribution device as claimed in claim 7 further including braces extending from the brush holder vessel to the back surface of the paint distribution panel.

11. A paint distribution device as claimed in claim 7 wherein the paint distribution panel slopes away from the brush holder from the top edge to the bottom edge.

12. A paint distribution device as claimed in claim 7 integrally molded from plastic material.

13. A paint distribution device as claimed in claim 7 wherein the paint distribution panel further includes a flange extending at an angle from each opposing side edge.

14. A paint distribution device comprising:
a bucket having a curved rim;
a brush holder having continuous sidewall extending from a bottom to a rim defining an open top;
a collar coupled to and surrounding the rim, the collar having a flat edge with a first end and a second end, and a curved edge extending from the first end to the second end around the rim;
a paint distribution panel having a front surface, a back surface, a top edge, a bottom edge, and opposing side edges, the top edge coupled to the flat edge of the collar with the back surface facing and spaced apart from the brush holder; and
a slot defined by a flange extending downwardly from the curved edge of the collar opposite the paint distribution panel and the brush holder, the rim of the bucket received in the slot.

15. A paint distribution device as claimed in claim 14 wherein the front surface of the paint distribution panel includes a plurality of protrusions.

16. A paint distribution device as claimed in claim 14 wherein the brush holder includes drain holes formed in the bottom thereof.

17. A paint distribution device as claimed in claim 14 further including braces extending from the brush holder vessel to the back surface of the paint distribution panel.

18. A paint distribution device as claimed in claim 14 wherein the paint distribution panel slopes away from the brush holder from the top edge to the bottom edge.

19. A paint distribution device as claimed in claim 14 integrally molded from plastic material.
